(19) United States
(12) Patent Application Publication
(10) Pub. No.: US 2006/0159256 A1
(43) Pub. Date: Jul. 20, 2006

(54) Microphone

(75) Inventor: Hiroshi Akino, Machida-shi (JP)

Correspondence Address: KANESAKA BERNER AND PARTNERS LLP, SUITE 300, 1700 DIAGONAL RD, ALEXANDRIA, VA, 22314-2848, US

(73) Assignee: KABUSHIKI KAISHA AUDIO-TECHNICA, Machida-shi (JP)

(21) Appl. No.: 11/327,448

(22) Filed: Jan. 9, 2006

(30) Foreign Application Priority Data
Jan. 14, 2005 (JP) 2005-007119

(51) Int. Cl. H04R 1/02; H04M 1/00

(52) U.S. Cl. 379/430; 381/388

(57) ABSTRACT

For example, in a headset microphone, sweat generated from the human body is surely prevented from intruding into a microphone unit through a support boom. In a microphone 1 which includes a mounting means (for example, a headband) 10 for mounting the microphone to the human body and a microphone unit 20 supported on the mounting means via a predetermined supporting member (for example, a support boom) 30, the microphone unit 20 being detachably mounted in a predetermined portion of the human body via the mounting means, pile is plantedly provided on the supporting member 30 by electrostatic flocking, and the pile is subjected to water repellent treatment.

### TECHNICAL FIELD

The present invention relates to a microphone used by being mounted on the human body. More particularly, the present invention relates to a water proofing means against sweat generated from the human body.

### BACKGROUND ART

As a microphone used by being mounted on the human body, a headset microphone and a tie clip microphone are available. For the headset microphone, a microphone unit is supported on a headband via a support boom, and is arranged near the mouth of a human being when the headband is mounted on the human head.

For the tie clip microphone, a tie clip shaped mounting element is attached to a predetermined portion of a microphone cord pulled out of a microphone unit, and the microphone unit is arranged near the mouth of a human being by locking the mounting element to, for example, a collar of clothes. That is to say, for the tie clip microphone, the microphone unit is supported on the tie clip shaped mounting element via the microphone cord.

The microphone of this type, in which the microphone unit is arranged near the mouth of a speaker, is under circumstances of being doused with waterdrops such as sweat generated from the human body, and if the waterdrops enter into the microphone unit, poor insulation or corrosion occurs, which results in the production of noise.

To prevent this trouble, in an invention described in Japanese Patent Application Publication No. 11-275672, the microphone unit is covered with a windscreen subjected to water repellent treatment. According to this invention, although spit discharged from the speaker's mouth can be intercepted, sweat generated from the head or neck cannot be prevented from entering into the microphone through the support boom or microphone cord.

To cope with this problem, for example, the Lavalier microphone CL77WR manufactured by AKG Acoustics in Germany is provided with a collar-shaped sheathing plate on the cord pullout side of the microphone unit. According to this configuration, sweat coming through the support boom or the microphone cord can be intercepted to some extent, but the collar-shaped sheathing plate does not function effectively if the amount of sweat is large because a sufficient creepage distance with respect to the microphone unit cannot be provided. Therefore, sweat sometimes intrudes into the microphone unit.

By increasing the diameter of the collar-shaped sheathing plate and by providing a sufficient creepage distance with respect to the microphone unit, sweat can be allowed to drop by gravity. However, the increased diameter of the collar-shaped sheathing plate is unfavorable in using the microphone and also in apearance, so that the size of the collar-shaped sheathing plate is restricted naturally.

### SUMMARY OF THE INVENTION

Accordingly, a problem with the present invention is to surely prevent waterdrops such as sweat generated from the human body from intruding into a microphone unit through a support beam or a microphone cord in a headset microphone or a tie clip microphone.

To solve the above problem, the present invention is characterized in that in a microphone which includes a mounting means for mounting the microphone to the human body and a microphone unit supported on the mounting means via a predetermined supporting member, the microphone unit being detachably mounted in a predetermined portion of the human body via the mounting means, pile is plantedly provided over a predetermined range from a root portion of the supporting member with respect to the microphone unit toward the mounting means side by electrostatic flocking, and the pile is subjected to water repellent treatment.

According to this configuration, since the pile is plantedly provided on the supporting member for supporting the microphone unit by electrostatic flocking, and the pile is subjected to water repellent treatment, the pile surface has a large wetting angle of waterdrop, and thus a sufficient creepage distance with respect to the microphone unit can be provided. Therefore, waterdrops adhering to the supporting member drop on the way to the microphone unit by means of gravity.

According to a preferred mode of the present invention, as the pile, a nylon pile with a thickness of 1 to 3 denier and a length of 0.5 to 1.0 mm is used. Also, as the pile, a black pile or a beige pile is used.

Since a nylon pile with a thickness of 1 to 3 denier and a length of 0.5 to 1.0 mm is used as the pile, an appearance such that the piles does not get tangled together and hence the feeling is good can be obtained. Also, the use of black pile can prevent reflection of light, and the use of beige pile can visually restrain the presence of microphone when the microphone is used on a television studio or a stage.

### BRIEF DESCRIPTION OF THE DRAWINGS

FIG. 1 is a front view showing one example of a headset microphone to which the present invention is applied; and

FIG. 2 is an enlarged sectional view of an essential portion of the present invention.

### DETAILED DESCRIPTION

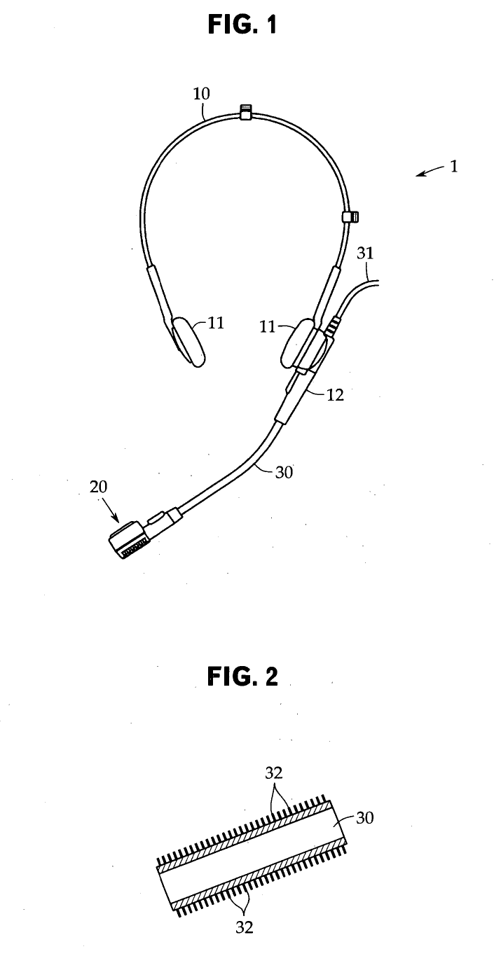

An embodiment of the present invention will now be described with reference to FIGS. 1 and 2. The present invention is not limited to this embodiment. FIG. 1 is a front view showing one example of a headset microphone to which the present invention is applied, and FIG. 2 is an enlarged sectional view of an essential portion of the present invention.

As shown in FIG. 1, a microphone 1 in accordance with this embodiment, which is of a headset type, includes a headband 10 serving as a mounting means for mounting the microphone to the human body. In this example, a headphone unit 11 is provided at both ends of the headband 10. However, the headphone unit 11 may be provided on one side only. Also, the headband 10 is formed so as to be arranged on the top of the head. Unlike this, the headband 10 may be formed so as to be set, for example, on the back of the head, or an ear-worn type mounting means may be used.

A microphone unit 20 is supported on the headband 10 via a support boom 30, and is arranged near the speaker's mouth by mounting the headband 10 on the head. In the case of the headset type, like the tie clip type, a small-size and light-weight condenser microphone unit is used for the microphone unit 20.

As the support boom 30, a pipe made of a synthetic resin or a metal is used. Alternatively, a flexible pipe may be used. In the support boom 30, a microphone cord 31 connected to the microphone unit 20 is inserted. In this example, the support boom 30 is connected to a hanger 12 provided on one end side of the headband 10 so as that the angle thereof can be adjusted.

When this microphone 1 is in use, the support boom 30 is arranged near the neck. Therefore, sweat generated from the head or the neck is liable to adhere to the support boom 30, and the adhering sweat intrudes into the microphone unit 20 through the support boom 30, causing poor isolation or corrosion, which sometimes results in the production of noise.

To avoid this drawback, in the present invention, as shown in FIG. 2, pile 32 is plantedly provided on the support boom 30 by electrostatic flocking, and then the pile 32 is subjected to water repellent treatment. The pile 32 is preferably provided plantedly over the total length of the support boom 30. However, the pile 32 may be plantedly provided over a predetermined range from a part of the support boom 30, namely, a root portion of the support boom 30 with respect to the microphone unit 20 toward the hanger 12 side.

As the pile 32, a publicly-known pile material such as synthetic fiber, natural fiber, and inorganic powder such as glass and ceramics can be used. In particular, from the viewpoint of appearance (feeling), a nylon pile with a thickness of 1 to 3 denier and a length of 0.5 to 1.0 mm, especially a nylon pile of 2 denier, is preferably used.

Also, as a water repellent, a PTFE (polytetrafluoroethylene) based or silicone based water repellent is preferably used. According to the water repellent of this kind, sweat showered on the pile 32 comes into contact with the tip end of the pile 32 as particulate and stays on the pile surface in the particulate state. However, the sweat having grown into large particles rolls down from the pile surface by means of gravity. The water repellent treatment need not necessarily be performed over the total length of the pile 32, and at least a tip end portion of the pile 32 has only to be subjected to water repellent treatment.

Regarding the color of the pile 32, black color can prevent reflection of light, and beige color can visually restrain the presence of microphone when the microphone is used on a television studio or a stage.

The above is an explanation of the present invention given by taking a headset microphone shown in FIG. 1 as an example. However, the present invention embraces a tie clip microphone. In this case, a tie clip shaped mounting element attached to a predetermined portion of a microphone cord pulled out of the microphone unit corresponds to the mounting means for mounting the microphone to the clothing of the human body. Also, since the microphone cord serves as a supporting member for the microphone unit, pile is plantedly provided on the microphone cord at least between the microphone unit and the tie clip shaped mounting element by electrostatic flocking, and the pile is subjected to water repellent treatment.

In the present invention, it is a matter of course that the microphone unit 20 may be covered with a windscreen subjected to water repellent treatment as described, for example, in Japanese Patent Application Publication No. 11-275672.

The present application is based on, and claims priority from, Japanese Application Serial Number JP2005-007119, filed Jan. 14, 2005, the disclosure of which is hereby incorporated by reference herein in its entirety.

1. A microphone which includes a mounting means for mounting the microphone to the human body and a microphone unit supported on the mounting means via a predetermined supporting member, the microphone unit being detachably mounted in a predetermined portion of the human body via the mounting means, wherein
pile is plantedly provided over a predetermined range from a root portion of the supporting member with respect to the microphone unit toward the mounting means side by electrostatic flocking, and the pile is subjected to water repellent treatment.

2. The microphone according to claim 1, wherein the pile is a nylon pile with a thickness of 1 to 3 denier and a length of 0.5 to 1.0 mm.

3. The microphone according to claim 1, wherein the pile is a black pile.

4. The microphone according to claim 1, wherein the pile is a beige pile.
